(19) United States
(12) Patent Application Publication
(10) Pub. No.: US 2014/0338469 A1
(43) Pub. Date: Nov. 20, 2014

(54) LOAD SENSOR

(71) Applicant: Panasonic Corporation, Osaka (JP)

(72) Inventor: KOUMEI FUJITA, Osaka (JP)

(21) Appl. No.: 14/450,293

(22) Filed: Aug. 4, 2014

Related U.S. Application Data
(63) Continuation of application No. PCT/JP2013/001386, filed on Mar. 6, 2013.

(30) Foreign Application Priority Data
Mar. 7, 2012 (JP) 2012-050042

(51) Int. Cl. G01L 1/10

(52) U.S. Cl. CPC G01L 1/10
USPC 73/862.59

(57) ABSTRACT

A load sensor includes a vibrator, a drive electrode provided at the vibrator, a drive circuit that supplies, to the drive electrode, a drive voltage for vibrating the vibrator, a detection electrode that outputs a current in response to a vibration of the vibrator, and an IV converter that converts the current output from the detection electrode into a voltage. The drive circuit includes an operational amplifier that outputs the drive voltage and a resistor connected to the operational amplifier. The drive circuit has a small internal resistance. The IV converter has an inverted input terminal that is virtually grounded and that has the current input thereto. The IV converter may constitute a negative feedback circuit.

This application is a continuation of the PCT international application PCT/JP2013/001386, filed on Mar. 6, 2013, the contents of which are incorporated herein by reference.

### TECHNICAL FIELD

The present invention relates to a load sensor for detecting an applied load.

### BACKGROUND ART

FIG. 13 is an exploded view of conventional sensor 501 that measures an ambient atmospheric pressure. Sensor 501 includes vibrator 1 made of crystal, case 2 for accommodating vibrator 1, electrode pattern 3 disposed inside case 2, and lead 5 that is electrically connected to vibrator 1 and outputs an oscillation output signal to the outside. Electrode pattern 3 is electrically connected to vibrator 1 with conductive paste 4.

FIG. 14 is a circuit block diagram of sensor 501 and shows a circuit for obtaining the oscillation output signal from vibrator 1. Sensor 501 includes oscillation circuit 6, gate 12 connected to oscillation circuit 6, and counter 13 connected to gate 12. Lead 5 shown in FIG. 13 is electrically connected to oscillation circuit 6, thereby electrically connecting vibrator 1 to oscillation circuit 6.

FIG. 15 is a circuit diagram of oscillation circuit 6. Vibrator 1 is electrically connected to ground 8 via a pair of capacitors 7 to be grounded. Resistor 9 and Colpitts oscillation inverter 10 are connected in parallel to vibrator 1 and are connected to ground 8 via a pair of capacitors 7 to be grounded. Waveform shaping inverter 11 waveform-shapes the signal output from Colpitts oscillation inverter 10, and outputs the waveform-shaped signal.

An operation of conventional sensor 501 will be described below. FIG. 16 shows a vibration frequency of vibrator 1. In FIG. 16, the horizontal axis represents an atmospheric pressure around vibrator 1, and the vertical axis represents a change of the vibration frequency. As shown in FIG. 16, the vibrational frequency of vibrator 1 changes with change in the atmospheric pressure. Oscillation circuit 6 oscillates at the vibrational frequency, and wave shaping inverter 11 outputs an oscillation signal to gate 12 shown in FIG. 14. Receiving the oscillation signal, gate 12 opens for a predetermined period from its closed state to allow the oscillation signal to pass through gate 12. Counter 13 counts the number of peaks of the oscillation signals passing through gate 12, and detects the vibrational frequency of vibrator 1, thereby allowing sensor 501 to measure the ambient atmospheric pressure.

A conventional sensor similar to sensor 501 is described in, e.g. PTL 1.

In conventional sensor 501, when a capacitance of vibrator 1 changes with change of the ambient temperature, the accuracy of output signals from sensor 501 is deteriorated.

### CITATION LIST

### Patent Literature

PTL 1: Japanese Laid-Open Patent Publication No. 57-136130

### SUMMARY

A load sensor includes a vibrator, a drive electrode provided at the vibrator, a drive circuit that supplies, to the drive electrode, a drive voltage for vibrating the vibrator, a detection electrode that outputs a current in response to a vibration of the vibrator, and an IV converter that converts the current output from the detection electrode into a voltage. The drive circuit includes an operational amplifier that outputs the drive voltage and a resistor connected to the operational amplifier. The drive circuit has a small internal resistance. The IV converter has an inverted input terminal that is virtually grounded and that has the current input thereto. The IV converter may constitute a negative feedback circuit.

The load sensor provides an accurate output signal stably even if an ambient temperature changes,

### BRIEF DESCRIPTION OF DRAWINGS

FIG. 1 is a side cross-sectional view of a load sensor in accordance with an exemplary embodiment.

FIG. 2A is a top view of a distortion detector of the load sensor in accordance with the embodiment.

FIG. 2B is a cross-sectional view of the distortion detector at line 2B-2B shown in FIG. 2A.

FIG. 3 is a circuit diagram a part of a processing circuit of the load sensor in accordance with the embodiment.

FIG. 4 shows a relation between an internal resistance of an operational amplifier and a phase variation in the processing circuit of the load sensor in accordance with the embodiment.

FIG. 5 shows waveforms of the load sensor in accordance with the embodiment.

FIG. 6 is a schematic view of the load sensor in accordance with the embodiment mounted to a bicycle.

FIG. 7 is an enlarged view of the load sensor shown in FIG. 6.

FIG. 8 shows a frequency of a vibrator of the load sensor in accordance with the embodiment.

FIG. 9 is a circuit diagram of the processing circuit of the load sensor in accordance with the embodiment.

FIG. 10 shows a change of a vibration frequency of a comparative example of a sensor.

FIG. 11 shows a change of a vibration frequency of an output signal with change of a capacitance of the vibrator of the load sensor in accordance with the embodiment.

FIG. 12 is a circuit diagram of another processing circuit of the load sensor in accordance with the embodiment.

FIG. 13 is an exploded view of a conventional sensor.

FIG. 14 is a circuit block diagram of the conventional sensor.

FIG. 15 is a circuit diagram of an oscillation circuit of the conventional sensor.

FIG. 16 shows a vibration frequency of a change of the conventional sensor.

### DETAIL DESCRIPTION OF PREFERRED EMBODIMENTS

### Exemplary Embodiment

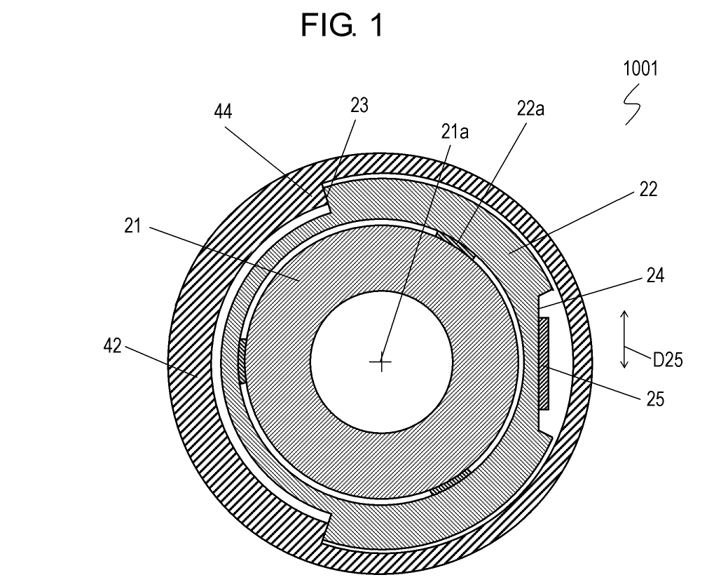

FIG. 1 is a side sectional view of load sensor 1001 in accordance with an exemplary embodiment. Rolling bearing 21 has a cylindrical shape extending about rotation axis 21a, and rotatably supports a shaft that rotates about rotation axis 21a. Rolling bearing 21 is fixed to an inside of stress-transferring member 22 of a cylindrical shape. Stress-transferring member 22 is disposed over the entire circumference of rolling bearing 21 in radial directions extending from rotation axis 21a. Three supporting sections 22a are disposed on the inside of stress-transferring member 22, so as to support rolling bearing 21 from the inside of stress-transferring member 22. Two contact sections 23 of a stepped shape are disposed on an outer circumference of stress-transferring member 22. Deformable section 24 having a linear shape is disposed on the outer side of stress-transferring member 22. Distortion detector 25 is attached onto deformable section 24 of stress-transferring member 22.

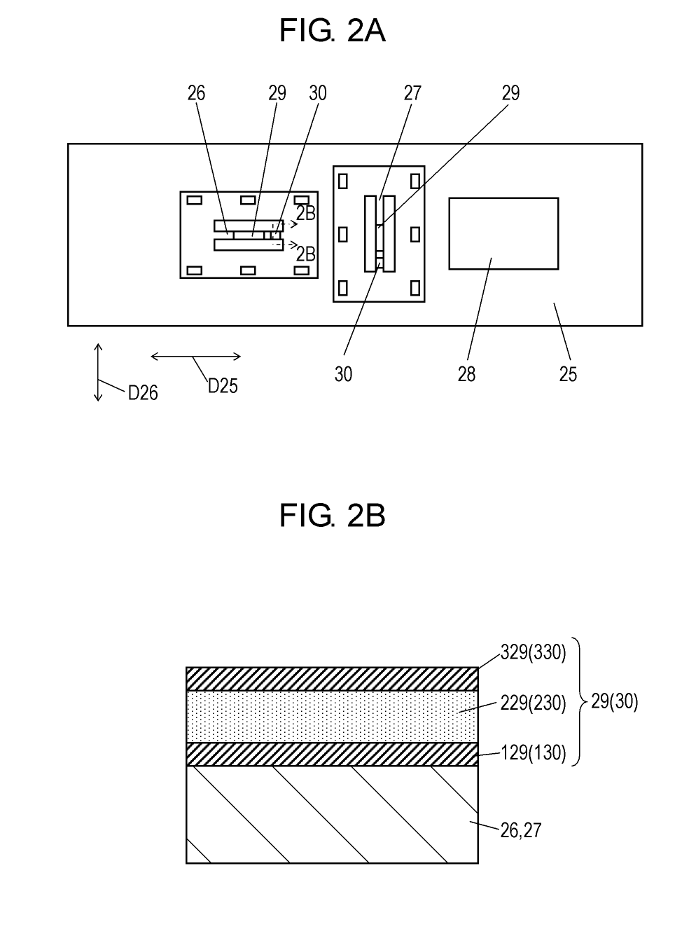

FIG. 2A is a top view of distortion detector 25. Distortion detector 25 extends in longitudinal direction D25 perpendicular to rotation axis 21a shown in FIG. 1. Distortion detector 25 includes vibrators 26 and 27 each having a fixed-fixed beam structure and processing circuit 28. Processing circuit 28 is implemented by an IC. Vibrator 26 has a fixed-fixed beam shape extending in longitudinal direction D25. Vibrator 27 has a fixed-fixed beam shape extending in direction D26 perpendicular to longitudinal direction D25. Processing circuit 28 causes both of vibrators 26 and 27 to vibrate, and processes output signals. Drive electrode 29 and detection electrode 30 are disposed on each of vibrators 26 and 27. Drive electrode 29 and detection electrode 30 disposed on vibrator 26, drive electrode 29 and detection electrode 30 disposed on vibrator 27, and processing circuit 28 are electrically connected with wiring patterns made of Au.

FIG. 2B is a sectional view of distortion detector 25 at line 2B-2B shown in FIG. 2A. Drive electrode 29 includes lower electrode layer 129 made of conductive material disposed on vibrator 26 (27), piezoelectric layer 229 made of piezoelectric material disposed on lower electrode layer 129, and upper electrode layer 329 made of conductive material disposed on piezoelectric layer 229. Similarly, detection electrode 30 includes lower electrode layer 130 made of conductive material disposed on vibrator 26 (27), piezoelectric layer 230 made of piezoelectric material disposed on lower electrode layer 130, and upper electrode layer 330 made of conductive material disposed on piezoelectric layer 230. According to the embodiment, lower electrode layer 130 is made of Pt, piezoelectric layer 230 is made of PZT, and upper electrode layer 330 is made of Au. Each of drive electrode 29 and detection electrode 30 has a capacitance formed between lower electrode layer 130 and upper electrode layer 330.

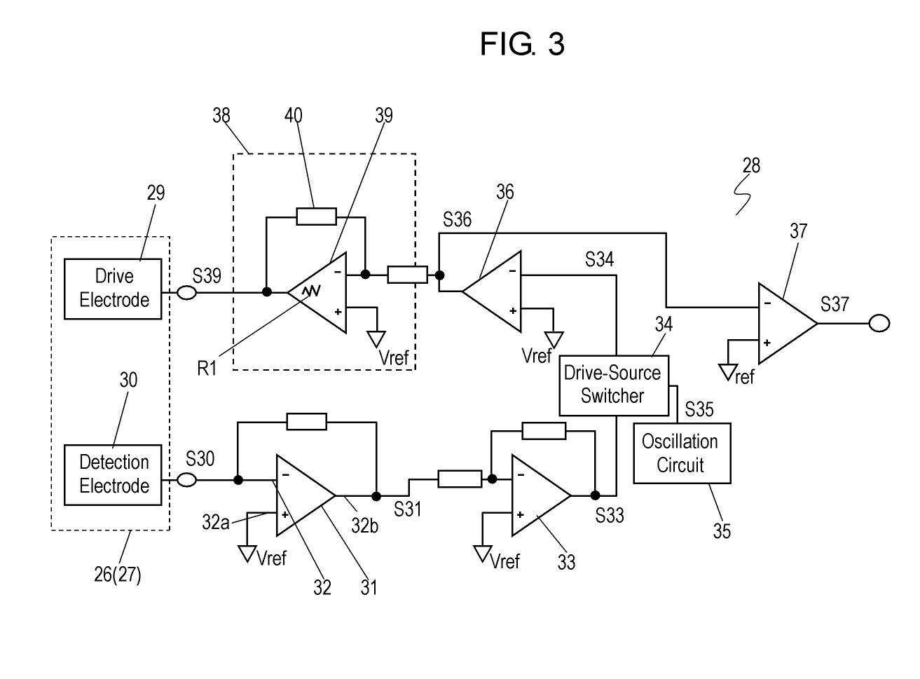

FIG. 3 is a circuit diagram of a part of processing circuit 28 of load sensor 1001. Processing circuit 28 includes IV converter 31, amplifiers 33 and 36, drive-source switcher 34, oscillation circuit 35, comparator 37, and drive circuit 38. IV converter 31 converts, into voltage, a current which is formed of electric charge supplied from detection electrode 30. IV converter 31 includes an operational amplifier having inverted input terminal 32, non-inverted input terminal 32a, and output terminal 32b. Non-inverted input terminal 32a of IV converter 31 is connected to a reference potential for grounding to virtually ground inverted input terminal 32. Amplifier 33 amplifies an output signal supplied from IV converter 31. Oscillation circuit 35 outputs a signal having a frequency of 200 kHz. According to the embodiment, oscillation circuit 35 is a CR oscillation circuit. Drive-source switcher 34 receives the output signal from amplifier 33. When the output signal from amplifier 33 has a frequency lower than 200 kHz, drive-source switcher 34 inputs an output signal from oscillation circuit 35 into amplifier 36. When the output signal from amplifier 33 has a frequency not lower than 200 kHz, drive-source switcher 34 inputs the output signal from amplifier 33 into amplifier 36. This structure a circuit placed downstream of the output of comparator 37 can operate before vibrators 26 and 27 are ready for vibrating at each natural frequency. This shortens a start-up time of load sensor 1001. Amplifier 36 amplifies the received signal and outputs the amplified as an output signal. The output signal from amplifier 36 is supplied to comparator 37. Receiving the output signal from amplifier 36, comparator 37 compares the signal with a predetermined threshold and shapes the output signal from amplifier 36 into a signal having a rectangular waveform, and then outputs it. The output signal from amplifier 36 is supplied into drive circuit 38. Drive circuit 38 supplies drive signals to drive electrode 29 for vibrating vibrators 26 and 27. Drive circuit 38 generates the drive voltages based on the output signal from detection electrode 30. Drive circuit 38 includes operational amplifier 39 and resistor 40. Internal resistance R1 of operational amplifier 39, angular frequency co (rad/sec) of the drive signal (drive voltage), allowable phase difference ω (degrees), the capacitance C (F) of drive electrode 29 of vibrator 26 (27) satisfy Formula 1

R1≦−(1/ωC)×tan(φ×(π/180)) (Formula 1)

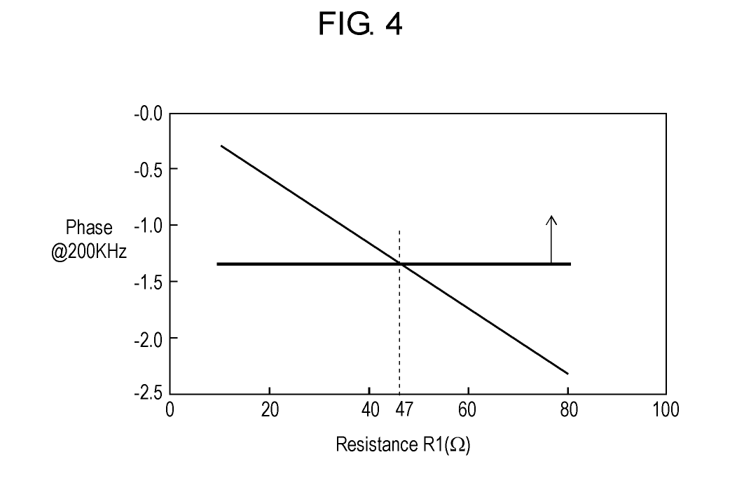

FIG. 4 shows a relation between internal resistance R1 of operational amplifier 39 and a change of the phase. In load sensor 1001 according to the embodiment, in the case that drive electrode 29 of each of vibrators 26 and 27 has a capacitance of 400 pF and a frequency detected at a drive frequency of 200 kHz has allowable phase difference φ of 1.35 degrees, and internal resistance R1 of operational amplifier 39 is a small value not larger than 47Ω2, as shown in FIG. 4.

A method of calculating allowable phase difference φ will be described below. Vibrator 26 (27) has resonance frequency fr of 200 kHz, a resonance sharpness Q is 600, and frequency change df at application of full-scale distortion is 1000 Hz. Further, an allowable error rate Er for a predetermined use is determined to be 0.5%.

Under the conditions above, in resonance characteristics of vibration amplitude of vibrator 26 (27), half bandwidth hf is calculated by the following formulas:

Q=fr/hf,

Hf=fr/Q=200×10³/600=333(Hz).

As the phase changes by 90 degrees (from 45 degrees to −45 degrees) at half bandwidth hf, phase gradient dp around resonance frequency fr is calculated by the following formula:

Dp=hf/90=333/90=3.7 (Hz/degree).

In distortion detector 25 according to the embodiment shown in FIG. 2A, when an external force is applied, natural frequency fa (i.e., the resonance frequency of vibrator 26) noticeably changes, whereas natural frequency fb (i.e., the resonance frequency of vibrator 27) changes little. From the reason above, hereinafter, the description will be focused on variations in natural frequency fa.

Allowable frequency error Ef which is derived from allowable error rate Er is calculated by the following formulas:

Er=Ef/df,

0.5 (%)=Ef/1000,

Ef=1000∴0.5%=5 (Hz).

Allowable phase difference φ is calculated by the following formula.

φ=Ef/dp=5 (Hz)/3.7 (Hz/degree)≈1.35 (degrees)

The output signal from drive circuit 38 is supplied to drive electrode 29 disposed at vibrators 26 and 27 so as to drive vibrators 26 and 27 to vibrate. Supporting member 42 is disposed on the outer circumference of stress-transferring member 22. Supporting member 42 has projecting section 44 that projects inwardly. Projecting section 44 contacts contact section 23 of stress-transferring member 22.

A method of manufacturing load sensor 1001 according to the embodiment will be described below.

First, vibrators 26 and 27 are formed by etching a semiconductor substrate made of Si.

Next, wiring patterns made of Au are deposited on an upper surface of the semiconductor substrate, and then, Pt is deposited on the positions at which drive electrode 29 and detection electrode 30 of vibrators 26 and 27 are disposed, thereby forming lower electrode layers 129 and 130.

Next, piezoelectric layers 229 and 230 are formed by depositing PZT on upper surfaces of lower electrode layers 129 and 130. Then, upper electrode layers 329 and 330 are formed by depositing Au on upper surfaces of piezoelectric layers 229 and 230. Drive electrode 29 and detection electrode 30 are thus formed on upper surfaces of vibrators 26 and 27.

Next, processing circuit 28 is mounted on the substrate. Processing circuit 28 is electrically connected to drive electrode 29 and detection electrode 30 disposed on each of vibrators 26 and 27, thereby providing distortion detector 25.

Next, distortion detector 25 is attached onto deformable section 24 of stress-transferring member 22. Then, rolling bearing 21 is fitted inside stress-transferring member 22 so that supporting sections 22a of stress-transferring member 22 may contact the outer circumference of rolling bearing 21.

Finally, stress-transferring member 22 is placed inside supporting member 42 so that contact sections 23 of stress-transferring member 22 meet with projecting section 44 of supporting member 42.

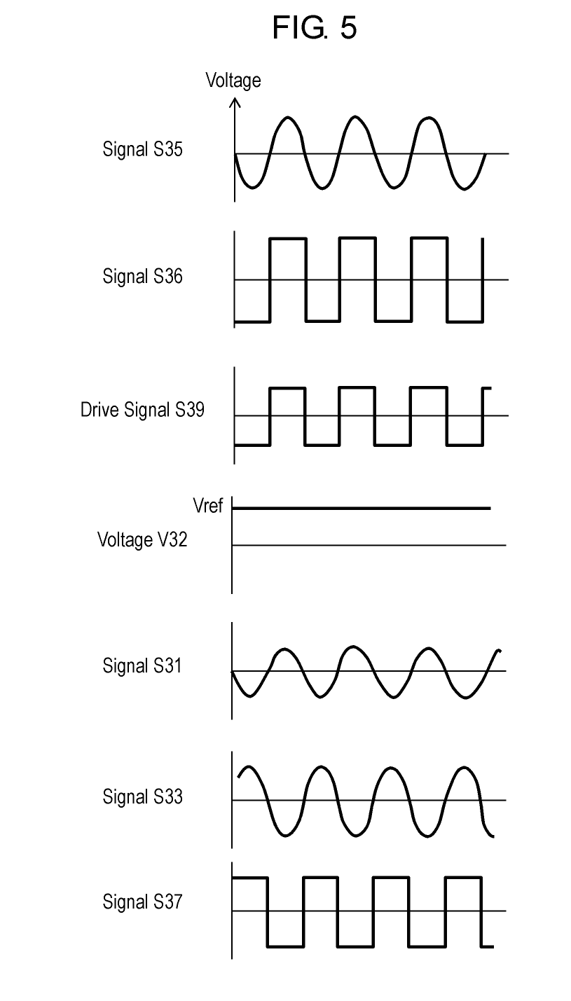

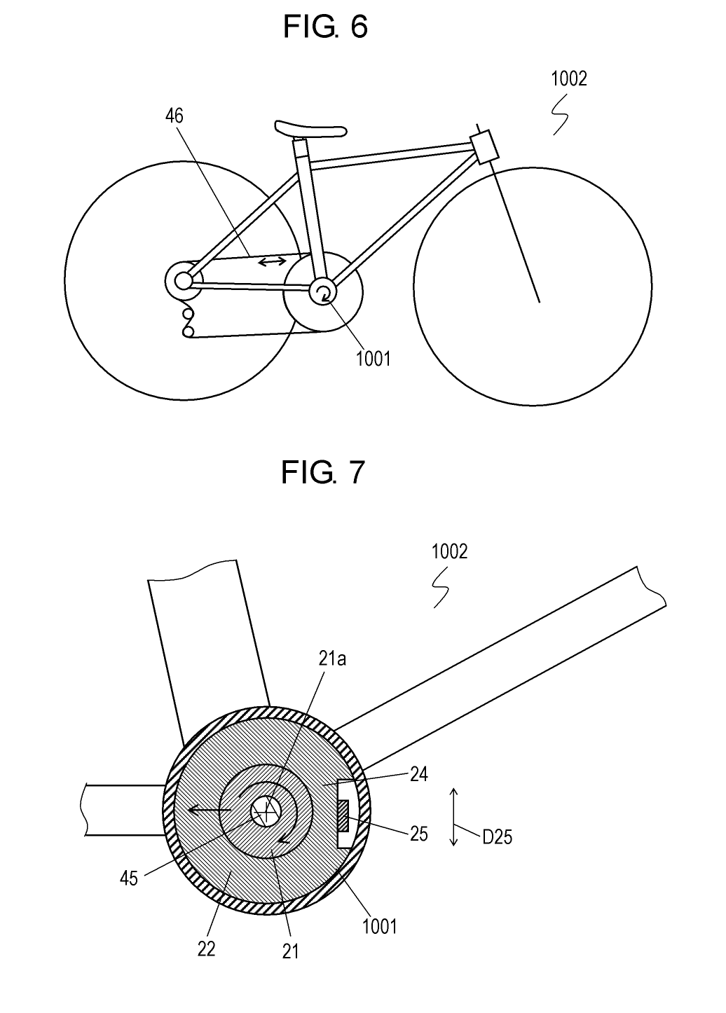

An operation of load sensor 1001 according to the embodiment will be described below. FIG. 5 shows waveforms of load sensor 1001. FIG. 6 is a schematic view of load sensor 1001 mounted to motor-assisted bicycle 1002. FIG. 7 is an enlarged view of load sensor 1001 shown in FIG. 6. In bicycle 1002, a man-powered drive system and an electric-motor drive system are disposed. A driving force of the electric motor functions in response to changes in a man-powered driving force.

Oscillation circuit 35 outputs signal S35 of a sinusoidal waveform having a frequency of 200 kHz to drive-source switcher 34. Through switching operation, drive-source switcher 34 outputs signal S35 as output signal S34. The output signal is amplified by amplifier 36 including a comparator, and the signal is compared with a predetermined threshold and then converted into output signal S36 of a rectangular waveform. Operational amplifier 39 limits amplitude of output signal S36 from amplifier 36 to form drive signal (drive voltage) S39 of a rectangular waveform. When output signal S39 is input to drive electrode 29 of each of vibrator 26 and vibrator 27, vibrator 26 performs a string vibration at natural frequency fa while vibrator 27 has string vibration at natural frequency fb. During the vibration, processing circuit 28 processes output signal S30 supplied from detection electrode 30 of vibrator 26 and detects frequency fa. Frequency fb is detected from detection electrode 30 of vibrator 27.

As shown in FIG. 6, when a person pedals the bicycle, the force applied to the pedals rotates rotation shaft 45 under the condition where chain 46 has tensile force, as shown in FIG. 7. The rotation of rotation shaft 45 exerts a force on rolling bearing 21 so as to move toward the rear wheel. The force is carried from rolling bearing 21 via supporting sections 22a to stress-transferring member 22, and urges stress-transferring member 22 toward the rear wheel. At that moment, a reaction force is exerted on contact sections 23 of stress-transferring member 22 from projecting section 44 of supporting member 42. The reaction force is transferred to deformable section 24 of stress-transferring member 22, and applies a compressive load in longitudinal direction D25 to deformable section 24.

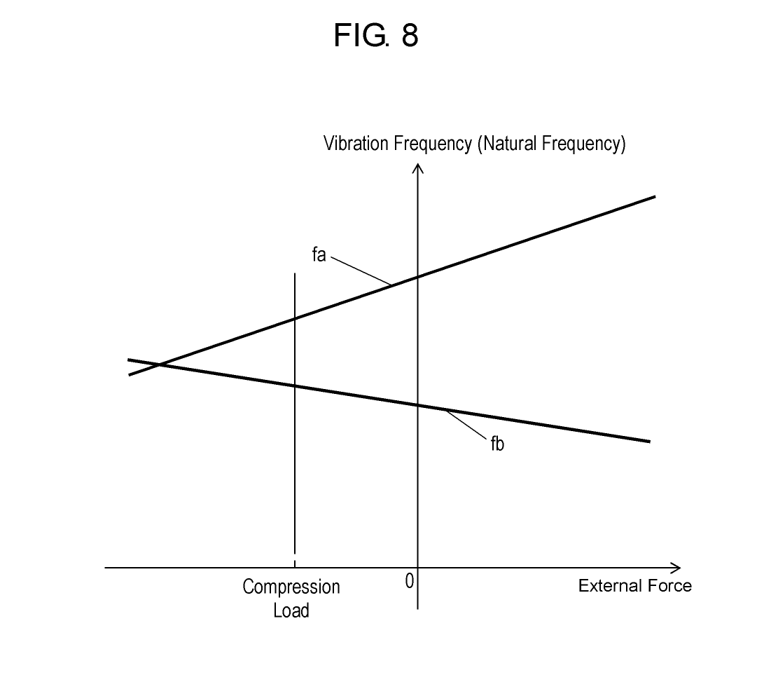

FIG. 8 shows natural frequencies fa and fb of vibrators 26 and 27, respectively. As shown in FIG. 8, in response to the compressive load in longitudinal direction D25, distortion detector 25 generates a tensile load in direction D26. That is, when the compressive load in longitudinal direction D25 is applied to distortion detector 25, natural frequency fa of vibrator 26 decreases while natural frequency fb of vibrator 27 increases. The output signal from detection electrode 30 of each of vibrator 26 and vibrator 27 is supplied into inverted input terminal 32 of IV converter 31 of processing circuit 28. Inverted input terminal 32 of IV converter 31 is virtually grounded, and therefore, potential V32 of inverted input terminal 32 is kept at a constant level, as shown in FIG. 5,. IV converter 31 converts the current generated due to electric charge which is supplied from detection electrode 30 of each of vibrators 26 and 27 into voltage. Then, IV converter 31 outputs output signal S31 corresponding to the frequencies of vibrator 26 and vibrator 27. Amplifier 33 amplifies output signal S31 from IV converter 31 while inverting the phase of the signal, and outputs output signal S33 shown in FIG. 5. When output signal S33 supplied from amplifier 33 has a frequency not lower than 200 kHz, output signal S33 from amplifier 33 is further amplified by amplifier 36. Then, comparator 37 converts the amplified signal into a rectangular-wave signal shown in FIG. 5 and outputs the signal as output signal S37. That is, the applied force onto the pedals can be detected from rectangular-wave output signal S37 that corresponds to changes of the frequencies.

Processing circuit 28 shown in FIG. 3 is connected to drive electrode 29 and detection electrode 30 of one of vibrators 26 and 27. In load sensor 1001, however, processing circuit 28 is connected to drive electrode 29 and detection electrode 30 of each of vibrators 26 and 27. Processing circuit 28 will be detailed below.

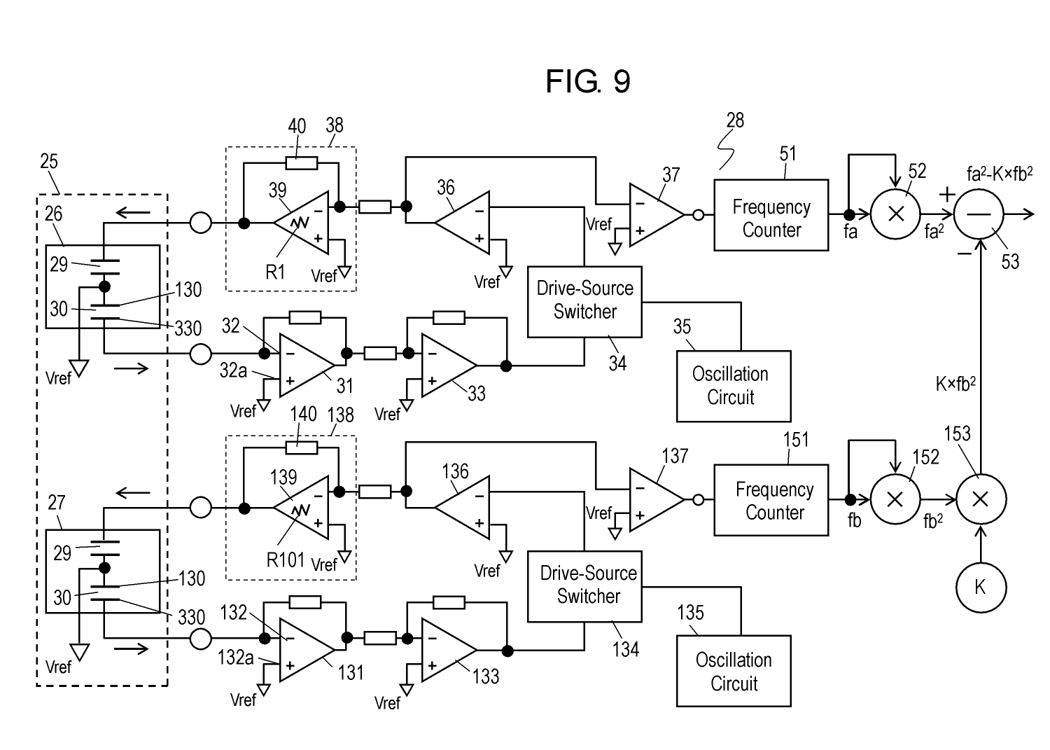

FIG. 9 is a circuit diagram of processing circuit 28 of load sensor 1001. In FIG. 9, components identical to those of processing circuit 28 shown in FIG. 3 are denoted by the same reference numerals. In processing circuit 28, operational amplifier 39 and IV converter 31 are connected to drive electrode 29 and detection electrode 30 of vibrator 26, respectively. Processing circuit 28 shown in FIG. 9 further includes drive circuit 138, IV converter 131, drive-source switcher 134, oscillation circuit 135, amplifiers 133 and 136, and comparator 137 which operates similar to drive circuit 38, IV converter 31, drive-source switcher 34, oscillation circuit 35, amplifiers 33 and 36, and comparator 37 shown in FIG. 3, respectively. Drive circuit 138 includes operational amplifier 139 and resistor 140 that operates similar to operational amplifier 39 and resistor 40 of drive circuit 38, respectively. Operational amplifier 139 has internal resistance R101 similar to internal resistance R1 of operational amplifier 39. Drive circuit 138 and IV converter 131 are connected to drive electrode 29 and detection electrode 30 of vibrator 27, respectively. Processing circuit 28 shown in FIG. 9 further includes frequency counters 51 and 151, multipliers 52 and 152, and 153, and subtracter 53.

An operation of load sensor 1001 including processing circuit 28 shown in FIG. 9 will be described below. Vibrators 26 and 27 have natural frequencies different from each other so as to prevent vibration interference between them. As shown in FIG. 8, when distortion is applied to vibrators 26 and 27, natural frequency fa (of vibrator 26) and natural frequency fb (of vibrator 27) change. The distortion can be detected by measuring the change of natural frequencies fa and fb.

Mechanical vibration of vibrators 26 and 27 is converted into electric charge by piezoelectric layer 230 of detection electrode 30 shown in FIG. 2B. Piezoelectric layer 230 outputs the electric charge as a current. Processing circuit 28 detects the current, and has a function of IV conversion for converting the current generated due to the electric charge into a voltage, a function of amplification for satisfying vibration conditions of vibrators 26 and 27, and a function of controlling drive voltages for driving vibrators 26 and 27 to allow the vibrators to vibrate with amplitudes within allowable ranges.

Since the piezoelectric material of piezoelectric layers 229 and 230 is a dielectric material, capacitances are produced between lower electrode layer 129 and upper electrode layer 329 of drive electrode 29 and between lower electrode layer 130 and upper electrode layer 330 of detection electrode 30. The capacitances provide the drive frequency with an error that will be described below. Dielectric materials have temperature characteristics that the permittivity changes with change in temperatures. The change in temperatures changes the capacitances and the drive frequency, causing the error.

In load sensor 1001, upper electrode layer 330 of detection electrode 30 disposed on vibrator 26 (27) is connected to inverted input terminal 32 (132) of IV converter 31 (131), while lower electrode layer 130 is connected to reference potential Vref. Non-inverted input terminal 32a (132a) of IV converter 31 (131) as an operational amplifier is connected to reference potential Vref. That is, inverted input terminal 32 (132) of IV converter 31 (131) is virtually grounded to reference potential Vref. This structure allows the potential difference between lower electrode layer 130 and upper electrode layer 330 of detection electrode 30 of vibrator 26 (27) to be zero, suppressing the current flowing into capacitances formed in piezoelectric layer 230. This suppresses a change of the drive frequency caused due to the capacitances when the current generated due to electric charge generated by distortion flows from detection electrode 30.

Internal resistance R1 (R101) of operational amplifier 39 (139) forming drive circuit 38 (138), i.e., output impedance, and the capacitance of each drive electrode 29 disposed on vibrators 26 and 27 constitute a low-pass filter. Internal resistance R1 (R101) of operational amplifier 39 (139), i.e., the output impedance is decreased to prevent the phase obtained by the low-pass filter constituted by the capacitance of drive electrode 29 and the output impedance of drive circuit 38 (138) from changing at about each natural frequency of vibrators 26 and 27. This suppresses a change of the drive frequency caused by the capacitance at the application of the drive voltage.

In processing circuit 28, comparators 37 and 137 output rectangular waves having a frequency identical to the frequency of the vibration of vibrators 26 and 27, respectively. Frequency counters 51 and 151 calculate the frequencies of the rectangular waves supplied from comparators 37 and 137, i.e., frequencies fa and fb of vibrators 26 and 27, respectively, and output the frequencies as digital data. The distortion applied to vibrators 26 and 27 is proportional to the squares of frequencies fa and fb, respectively. Vibrator 26 and vibrator 27 have natural frequencies different from each other, and therefore, the sensitivities of vibrators 26 and 27, i.e., the values of the squares of natural frequencies fa and fb per unit magnitude of the distortion are different from each other. Multipliers 52, 152, and 153 and subtracter 53 calculate difference Id based on Formula 2 with the ratio K of sensitivities of vibrator 26 and vibrator 27.

Id=fa²−K×fb² (Formula 2)

Difference Id in Formula 2 does not change due to, e.g. thermal expansion in which vibrators 26 and 27 have an equal amount of distortion. In order to detect distortion caused by the external force to be detected, vibrators 26 and 27 are disposed at positions where vibrators 26 and 27 are opposite in polarity the changes of the frequencies. Therefore, the distortion can be detected with no occurrence of the canceling effect as described above.

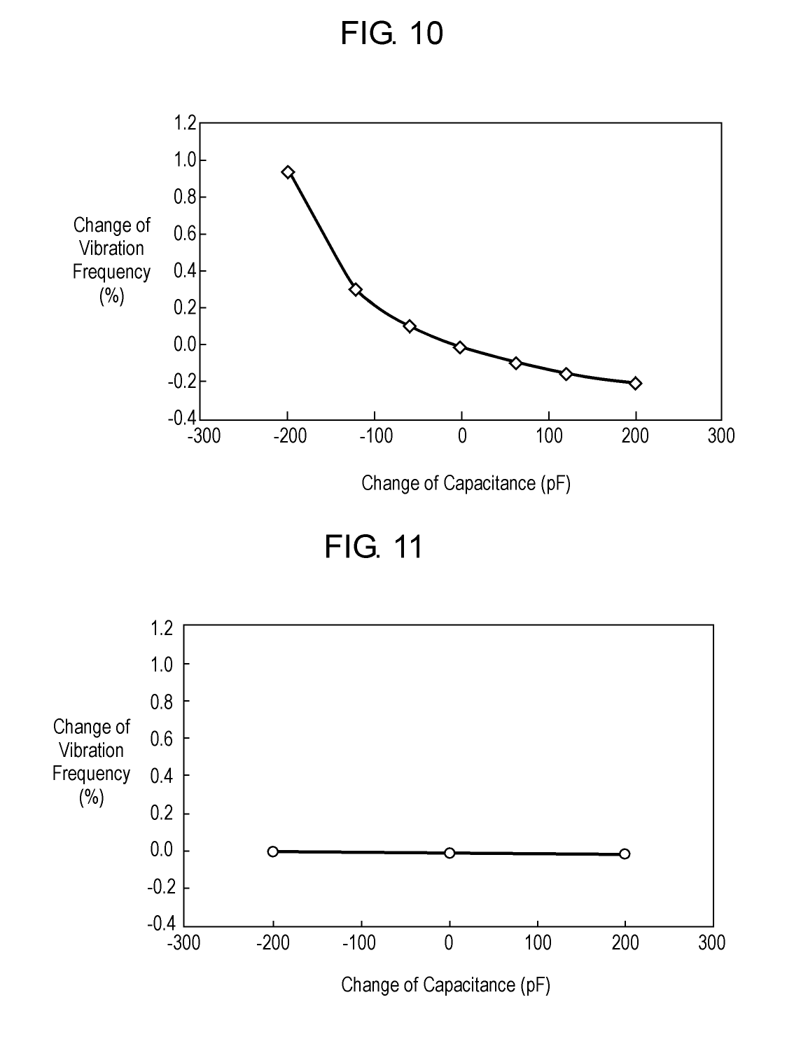

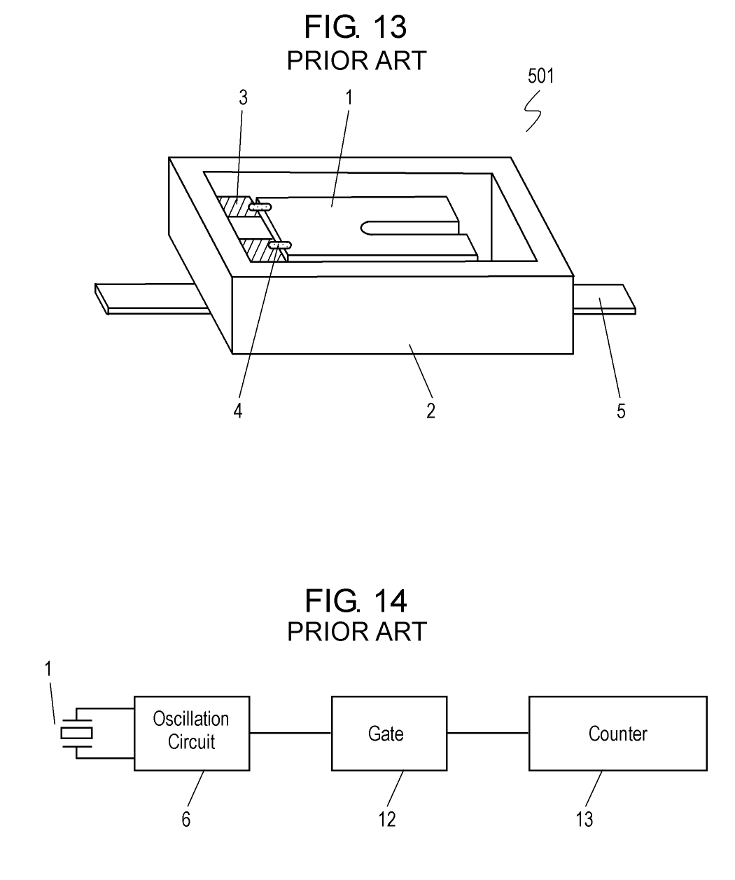

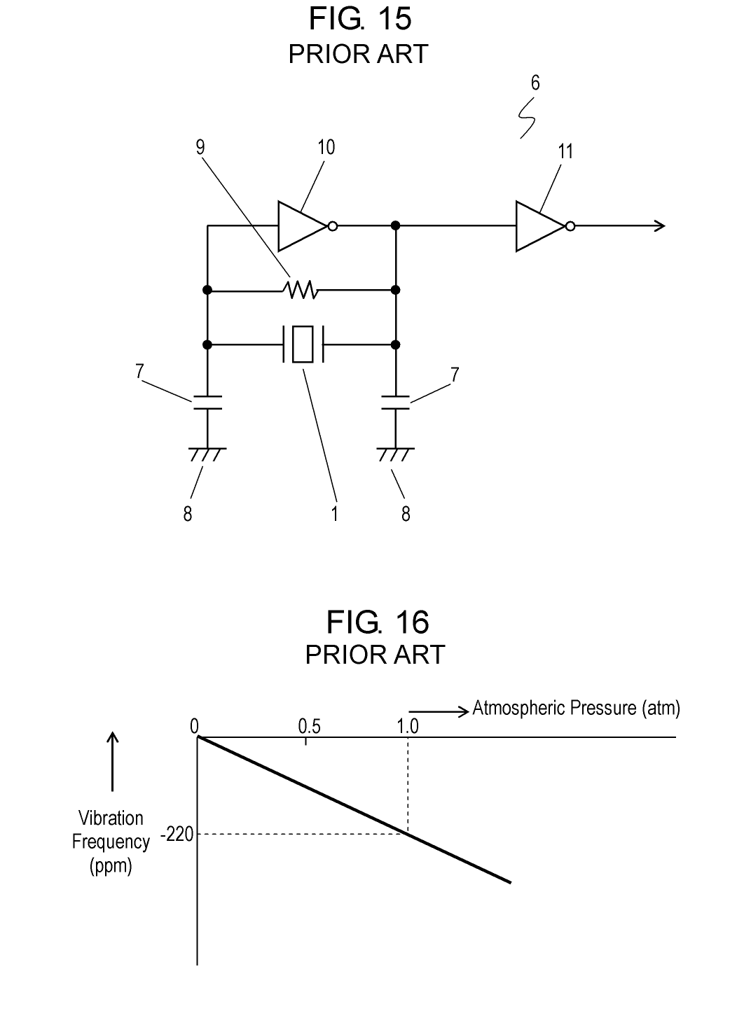

In conventional sensor 501 as a comparative example shown in FIGS. 13 to 15, oscillation circuit 6 employs a voltage detection system of Colpitts oscillation, so that the capacitance of vibrator 1 changes with the change of temperatures around sensor 501. FIG. 10 shows variations in a vibration frequency of sensor 501 as the comparative example with change of the capacitance of vibrator 1. As shown in FIG. 10, the change of the capacitance of vibrator 1 changes the vibration frequency, and degrades accuracy of the output signal supplied from sensor 501.

FIG. 11 shows changes of a vibration frequency of an output signal with a change of capacitance of vibrators 26 and 27 of load sensor 1001 in accordance with the embodiment. In load sensor 1001 according to the embodiment, since internal resistance R1 of drive circuit 38 is small, the phase difference between the current from IV converter 31 (131) and the drive voltage determined by internal resistance R1 (R101) and the capacitance of drive electrode 29 to be kept small even when the capacitance of drive electrode 29 changes due to the change of the ambient temperature. Further, since inverted input terminal 32 (132) of IV converter 31 (131) is virtually grounded, the current supplied from IV converter 31 (131) does not affect the current flowing in the capacitance component of detection electrode 30 disposed at vibrators 26 and 27. This structure, as shown in FIG. 11, the natural frequencies of vibrators 26 and 27 are not affected by the capacitances of drive electrode 29 and detection electrode 30 of vibrators 26 and 27. That is, even if the capacitances of drive electrode 29 and detection electrode 30 of vibrators 26 and 27 changes due to the change of the surrounding temperature, the frequency of the output signal does not change, and being accurate stably.

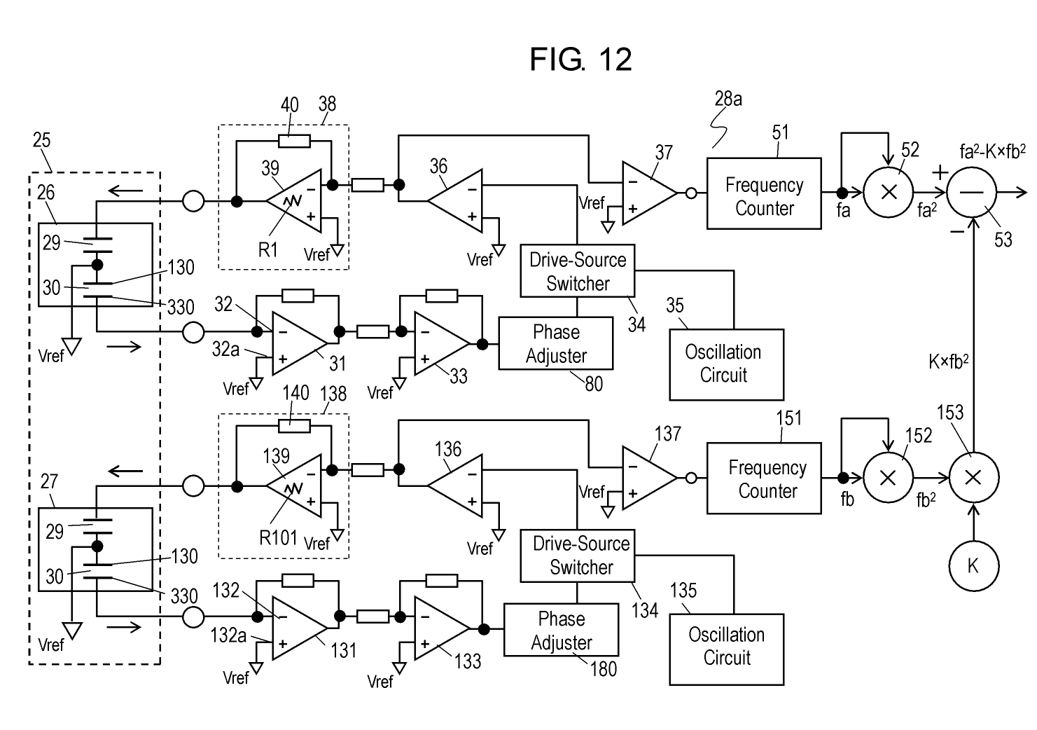

FIG. 12 is a circuit diagram of another processing circuit 28a of load sensor 1001. In FIG. 12, components identical to those of processing circuit 28 shown in FIG. 9 are dented by the same reference numerals. Processing circuit 28a further includes phase adjusters 80 and 180 that adjust the phases of the output signals from amplifiers 33 and 133, respectively. As described earlier, drive electrodes 29 and 129 and detection electrodes 30 and 130 have capacitances. Due to the capacitances, the drive signals produced in response to the output signals from detection electrodes 30 and 130 have phase differences with respect to the mechanical vibrations of vibrators 26 and 27. In processing circuit 28 shown in FIGS. 3 and 9, the phase differences may prevent efficient vibrations of vibrators 26 and 27.

In processing circuit 28a shown in FIG. 12, phase adjusters 80 and 180 shifts the phases of the output signals from amplifiers 33 and 133, respectively, and outputs the signal having the shifted phases. Drive circuits 38 and 138 produce drive signals based on the signals output from phase adjusters 80 and 180, and send the signals to drive electrode 29 of each of vibrators 26 and 27, respectively. This structure provides vibrators 26 and 27 with efficient vibration.

### INDUSTRIAL APPLICABILITY

A load sensor with according to the present invention does not degrade accuracy of output signals, and useful for a load sensor mounted to motor-assisted bicycle.

### REFERENCE MARKS IN THE DRAWINGS

26 Vibrator

27 Vibrator

29 Drive Electrode

30 Detection Electrode

31 IV Converter

32 Inverted Input Terminal

38 Drive Circuit

39 Operational Amplifier

40 Resistor

R1 Internal Resistance

1. A load sensor comprising:
a vibrator;
a drive electrode provided at the vibrator;
a drive circuit that supplies, to the drive electrode, a drive voltage for vibrating the vibrator;
a detection electrode that outputs a current in response to vibration of the vibrator; and
an IV converter that converts the current output from the detection electrode into a voltage and outputs the voltage as an output signal,
wherein the drive circuit includes an operational amplifier that outputs the drive voltage,
wherein the drive circuit generates the drive voltage based on the output signal, and
wherein internal resistance R1 (Ω) of the operational amplifier, angular frequency ω (rad/sec) of the drive voltage, allowable phase difference φ (degrees), and capacitance C (F) of the drive electrode satisfy a formula: R1≦−(1/ωC)×tan(φ×(π/180)).

2. The load sensor according to claim 1, wherein the IV converter has an inverted input terminal that is virtually grounded and that has the current input thereto, and, the IV converter constituting a negative feedback circuit.

3. The load sensor according to claim 2, further comprising
a phase adjuster that adjusts a phase of the output signal and outputs the signal having the adjusted phase,
wherein the drive circuit generates the drive voltage based on the signal output from the phase adjuster.

4. The load sensor according to claim 1, further comprising
a phase adjuster that adjusts a phase of the output signal and outputs the signal having the adjusted phase,
wherein the drive circuit generates the drive voltage based on the signal output from the phase adjuster.
